(19) United States
(12) Patent Application Publication
(10) Pub. No.: US 2008/0016073 A1
(43) Pub. Date: Jan. 17, 2008

(54) CONTENT SELECTION DEVICE AND CONTENT SELECTION PROGRAM

(76) Inventors: Junichi KOBAYASHI, Neyagawa-shi (JP); Shogo Sugihara, Neyagawa-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/766,131

(22) Filed: Jun. 21, 2007

(30) Foreign Application Priority Data
Jun. 29, 2006 (JP) 2006-180222

(51) Int. Cl. G06F 3/048; G06F 17/30

(52) U.S. Cl. 707/7; 715/811; 707/E17.106

(57) ABSTRACT

A content selection device 1 of the present invention is connected to an audio player storing a content list being a list of tune titles, and to a display displaying a portion of the content list on an OSD screen. A total number identifying section 13 of the content selection device 1 identifies the total number of tunes in the content list. A skip value setting section 15 determines a skip value obtained by multiplying the identified total number of tunes by a predetermined skip rate. In response to the activation of a scroll button 50 on a remote controller 5, a scrolling section 16 identifies a set of tune titles to be displayed on the OSD screen after scrolling the portion of the content list being displayed on the OSD screen by the skip value. An OSD instruction section 11 produces an OSD signal for displaying the identified tune titles on the OSD screen, and sends the produced OSD signal to the display.

### BACKGROUND OF THE INVENTION

1. Field of the Invention

The present invention relates to a content selection device and, more particularly, to a content selection device used for finding and selecting an intended content item from among a list of content items by moving a portion of the content list to be displayed on a display screen based on a user operation.

2. Description of the Related Art

With the increase in the storage size of storage devices, recent AV devices can store a large amount of content. For example, some portable audio players can store more than 10000 tunes.

With the increase in the number of content items that can be stored in an AV device, it takes longer for the user to find an intended content item. Therefore, there is a demand for a mechanism by which the user can effectively find an intended content item.

Methods for finding an intended content item from a database storing a large amount of content items include those based on a string search operation and those in which the stored content items are indexed and the user can select an index based on which a subset of content items are extracted. In either method, a “search key” (e.g., a character string or an index) is selected, and data that match the “search key” are extracted, thereby realizing an effective method for finding an intended content item.

However, extracting data that match a certain “search key” imposes a high computational load, and requires a device with a high operation speed such as a central processing unit (CPU) in order to extract data in a short time. An ordinary AV device is usually provided with a microcomputer slower than a CPU, and takes long to extract data matching a search key. Therefore, with such a device, the user cannot find an intended content item efficiently. The string search method requires a keyboard for inputting an intended character string.

Another method for finding a content item is a method in which the user operates control buttons to scroll, forward or backward, the content list displayed on the display screen. The user operates a push button, or the like, to scroll the content list until an intended tune title is displayed on the screen. When the intended tune title is displayed, the user then moves the cursor to select the tune title. This method does not require a high processing speed, and can be realized by a microcomputer, or the like.

However, with a very large number of content items listed in the content list, the user will need to operate control buttons, etc., a very large number of times. For example, where 100 tune titles are listed in the content list and up to five tune titles can be displayed at once on the display screen, if a single activation of a control button skips five tunes along the list (i.e., a single activation of the control button is equal to a page scroll), an intended tune can be found displayed on the display screen through 20 activations of the control button at maximum. However, if there are 10000 tune titles listed in the content list, the control button needs to be activated 2000 times at maximum before an intended tune title is displayed. Therefore, with such a method, the user cannot find an intended content item efficiently.

### SUMMARY OF THE INVENTION

It is therefore an object of the present invention to provide a content selection device with which the user can efficiently find and select an intended content item.

A content selection device of the present invention can be connected to a content storage device, a display device and an input device via a wired or wireless connection. The content storage device stores a plurality of content items and a content list being a list of content attributes for identifying the content items. The display device has a display screen for displaying a subset of the content attributes listed in the content list. The input device outputs a plurality of commands according to user operations.

The content selection device includes a total number identifying section, a skip value setting section, a top-of-screen content attribute identifying section, a display attribute specifying section, a display instruction section, a cursor moving section, and a content attribute selecting section. The total number identifying section identifies a total number of content attributes in the content list. The skip value setting section determines a skip value being a predetermined percentage of the identified total number of content attributes. The top-of-screen content attribute identifying section, when a list scroll command including a scrolling direction is received from the input device, identifies a top-of-screen content attribute being one of the content attributes listed in the content list that is offset from a content attribute being displayed at a top of the display screen by a distance corresponding to the skip value in the scrolling direction. The display attribute specifying section specifies a set of content attributes from among the content attributes listed in the content list, the set including a number of content attributes listed in a forward direction in the content list starting from the top-of-screen content attribute, the number of content attributes in the set corresponding to a maximum display number of the display screen. The display instruction section instructs the display device to sequentially display, on the display screen, the set of content attributes identified by the display attribute specifying section, starting from the top-of-screen content attribute. The cursor moving section, when a cursor moving command including a cursor moving direction is received from the input device, moves a cursor on the display screen by one content attribute in the cursor moving direction. The content attribute selecting section, when a select command is received from the input device, selects one of the set of content attributes displayed on the display screen that is being specified by the cursor.

A content file as used herein may be, for example, a video file, a tune file, a sound file, a still image file, or the like. The content attribute of a content file as used herein is a piece of information for identifying the content file, and may be, for example, the title of a content file, the tune title of a tune file, the name of an artist, the title of an album, or the name of the director of a video file, the name of a main actor of a video file, the date of recording of a video file, the “last watched” date of a video file, or the like.

Preferably, the content list includes a plurality of content numbers, which indicate an order in which the content attributes are sorted; and the top-of-screen content attribute identifying section identifies a content number associated with a content attribute being displayed at a top of the display screen, calculates a content number obtained by adding the skip value to the identified content number, and identifies a content attribute associated with the calculated content number as being the top-of-screen content attribute.

Preferably, the skip value setting section determines the skip value by multiplying the total number of content attributes by a predetermined skip rate.

The content selection device of the present invention determines a skip value proportional to the total number of content attributes listed in the content list. A number of content attributes corresponding to the skip value proportional to the total number of content attributes can be skipped by a single command, whereby it is possible to suppress the total number of commands needed before the user reaches the intended content attribute. Unlike conventional methods in which data matching a “search key” are extracted so as to select an intended content attribute, such as those based on a string search operation, the present invention merely scrolls the content list up or down according to commands issued, whereby the computational load on the device is small. Therefore, it is possible to efficiently find and select the intended content item even with a device or microcomputer of a slow processing speed.

Preferably, each time a skip value changing command is received from the input device, the skip rate is decreased, and the skip value setting section determines the skip value by multiplying the total number of content attributes by the decreased skip rate.

In such a case, a plurality of skip values can be set. Therefore, the user can reach the intended content attribute while gradually decreasing the number of content attributes to be skipped by a single command.

Preferably, if the skip value obtained by multiplication by the skip rate is smaller than the maximum display number of the display screen, the skip value setting section determines the skip value to be equal to the maximum display number.

If the skip rate is small, the skip value obtained by multiplying the total number of content attributes by the skip rate may be smaller than the maximum display number of the display screen. In such a case, the number of content attributes that can be skipped by a single command is small, which is inefficient for finding the intended content item. By setting the skip value to be equal to the maximum display number of the display screen when the obtained skip value is smaller than the maximum display number, it is possible to suppress the total number of commands to be issued before the user reaches the intended content item.

Preferably, the content selection device further includes means for identifying a downward jump destination content attribute being one of the content attributes listed in the content list that is offset from the identified top-of-screen content attribute by a distance corresponding to the skip value in a forward direction of the content list, and identifying an upward jump destination content attribute being one of the content attributes listed in the content list that is offset from the identified top-of-screen content attribute by a distance corresponding to the skip value in a backward direction of the content list. The display instruction section instructs the display screen to display information regarding the identified downward jump destination content attribute and information regarding the identified upward jump destination content attribute. The information regarding the downward jump destination content attribute and the information regarding the upward jump destination content attribute may be, for example, a part of the downward jump destination content attribute, e.g., the first letter of the downward jump destination content attribute or a predetermined number of letters thereof starting from the first letter. Alternatively, the information regarding the downward jump destination content attribute may be the downward jump destination content attribute itself.

In such a case, the display screen shows a portion of the content list as well as the information regarding the downward jump destination content attribute and the information regarding the upward jump destination content attribute. Therefore, the user can predict, to some extent, the set of content attributes to be displayed next time a list scroll command is issued. Thus, it is possible to prevent the user from scrolling the content list past the intended content attribute.

A content selection device of the present invention includes a content storage device, a display device, a input device, a total number identifying section, a skip value setting section, a top-of-screen content attribute identifying section, a display attribute specifying section, a display instruction section, a cursor moving section, and a content attribute selecting section. The content storage device stores a plurality of content items and a content list being a list of content attributes for identifying the content items. The display device has a display screen for displaying a subset of the content attributes listed in the content list. The input device includes a plurality of push buttons for outputting a plurality of commands according to user operations. The total number identifying section identifies a total number of content attributes in the content list. The skip value setting section determines a skip value being a predetermined percentage of the identified total number of content attributes. The top-of-screen content attribute identifying section, when a list scroll command including a scrolling direction sent from the input device in response to an activation of one of the push buttons is received, identifies a top-of-screen content attribute being one of the content attributes listed in the content list that is offset from a content attribute being displayed at a top of the display screen by a distance corresponding to the skip value in scrolling direction of the content list. The display attribute specifying section specifies a set of content attributes from among the content attributes listed in the content list, the set including a number of content attributes listed in a forward direction in the content list starting from the top-of-screen content attribute, the number of content attributes in the set corresponding to a maximum display number of the display screen. The display instruction section instructs the display device to sequentially display, on the display screen, the set of content attributes identified by the display attribute specifying section, starting from the top-of-screen content attribute. The cursor moving section, when a cursor moving command including a cursor moving direction sent from the input device in response to an activation of one of the push buttons is received, moves a cursor on the display screen by one content attribute in the cursor moving direction. The content attribute selecting section, when a select command sent from the input device in response to an activation of one of the push buttons is received, selects one of the content attributes displayed on the display screen that is being specified by the cursor.

The content selection device of the present invention determines a skip value proportional to the total number of content attributes listed in the content list. Each time a push button on the input device is pressed, a number of content attributes corresponding to the skip value determined based on the total number of content attributes are skipped, and the new set of content attributes are displayed on the display screen. Therefore, it is possible to suppress the number of commands needed to be issued (i.e., the number of times the push button needs to be pressed) before the user reaches the intended content attribute.

### BRIEF DESCRIPTION OF THE DRAWINGS

FIG. 1 is a functional block diagram showing how a content selection device in one embodiment of the present invention is connected to an audio player, a display, an amplifier and a remote controller.

FIG. 2 shows an example of an OSD screen displayed on the display shown in FIG. 1.

FIG. 3 shows the relationship between the content list stored in the content selection device shown in FIG. 1 and the OSD screen.

FIG. 4 shows the concept of the content selection process in one embodiment of the present invention.

FIG. 5 shows another example of an OSD screen different from that shown in FIG. 2.

FIG. 6 is a functional block diagram showing a configuration of the content selection device and the remote controller shown in FIG. 1.

FIG. 7 is a diagram showing a data structure of a content list stored in a RAM shown in FIG. 6.

FIG. 8 is a functional block diagram showing a configuration of the audio player shown in FIG. 1.

FIG. 9 is a flow chart showing the details of the skip value setting process among other processes performed by the content selection device shown in FIG. 6.

FIG. 10 shows an example of the relationship between the skip rate obtained in step S103 shown in FIG. 9 and the maximum number of commands.

FIG. 11 shows an example of an OSD screen to be displayed on the display receiving an OSD signal produced in step S107 shown in FIG. 9.

FIG. 12 is a flow chart showing the details of the skip process among other processes performed by the content selection device shown in FIG. 6.

FIG. 13 shows an example of the OSD screen after performing the skip process once from the OSD screen shown in FIG. 11.

FIG. 14 shows another example of an OSD screen different from those shown in FIGS. 2, 5, 11 and 13.

FIG. 15 is a flow chart showing the details of the skip value changing process among other processes performed by the content selection device shown in FIG. 6.

FIG. 16 shows another example of an OSD screen different from those shown in FIGS. 2, 5, 11, 13 and 14.

FIG. 17 shows another example of an OSD screen different from those shown in FIGS. 2, 5, 11, 13, 14 and 16.

FIG. 18 is a flow chart showing the details of the cursor moving process among other processes performed by the content selection device shown in FIG. 6.

FIG. 19 shows another example of an OSD screen different from those shown in FIGS. 2, 5, 11, 13, 14, 16 and 17.

FIG. 20 is a flow chart showing the details of the reproduction instruction process among other processes performed by the content selection device shown in FIG. 6.

FIG. 21 shows the external appearance of another remote controller different from that shown in FIG. 6.

FIG. 22 shows the external appearance of still another remote controller different from those shown in FIGS. 6 and 21.

FIG. 23 shows the external appearance of yet another remote controller different from those shown in FIGS. 6, 21 and 22.

FIG. 24 shows the external appearance of an audio player including a content selection device therein.

### DETAILED DESCRIPTION OF THE PREFERRED EMBODIMENTS

A preferred embodiment of the present invention will now be described with reference to the drawings. Like elements are denoted by like reference numerals throughout the various figures, and will not be described repeatedly.

### General Configuration

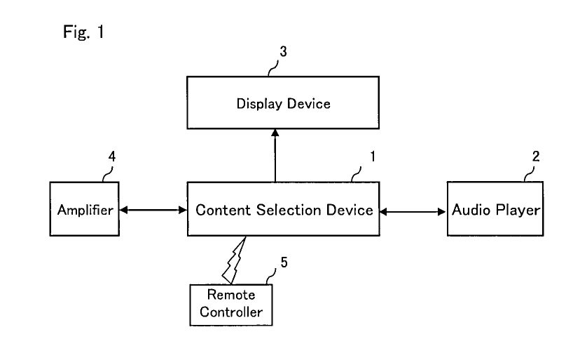

Referring to FIG. 1, a content selection device 1 of the present embodiment is connected to an audio player 2, serving as the content storage device, a display device 3, and an amplifier 4. The content selection device 1 is controlled by a remote controller 5, serving as the input device.

The audio player 2 stores a plurality of content files, and is capable of reproducing a selected content file. A content file can be, for example, a video file, a tune file, a sound file, a still image file, or the like. Herein, content files are assumed to be tune files.

Moreover, the audio player 2 stores a content list, which is a list of content attributes. A content attribute of each tune file may be a tune title, an artist name, or the like, of that tune file. The content attributes are sorted in the content list. Herein, content attributes listed in the content list are assumed to be tune titles.

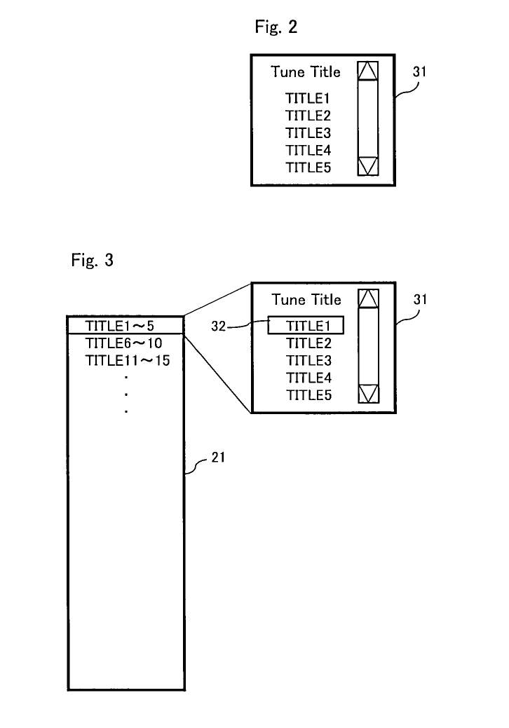

The display device 3 displays a portion of the content list stored in the audio player 2 on an OSD (On Screen Display) screen 31. Specifically, tune titles of five tunes (e.g., “TITLE1” to “TITLE5”) out of the content list including a plurality of tune titles may be displayed on the OSD screen 31, as shown in FIG. 2.

The content selection device 1 has an OSD display function, and displays the OSD screen 31 on the display device 3. Moreover, the content selection device 1 scrolls, forward or backward, the content list on the OSD screen 31 according to a command from the remote controller 5 based on a user operation. When the content selection device 1 is instructed by the remote controller 5 (based on a user operation) to reproduce an intended tune, the content selection device 1 instructs the audio player 2 to reproduce the tune file. Moreover, the content selection device 1 relays a sound signal from the audio player 2 to the amplifier 4.

The user uses push buttons on the remote controller 5 to scroll, forward or backward, the content list on the OSD screen 31 to find an intended tune title. The user can listen to the intended tune by selecting the intended tune title on the OSD screen 31 and sending a reproduction instruction to the content selection device 1.

### Concept of Content Selection Process

The concept of the content selection process according to the present invention will now be described. Herein, it is assumed that the content list includes titles of 10000 tunes (“TITLE1” to “TITLE10000”) sorted in alphabetical order.

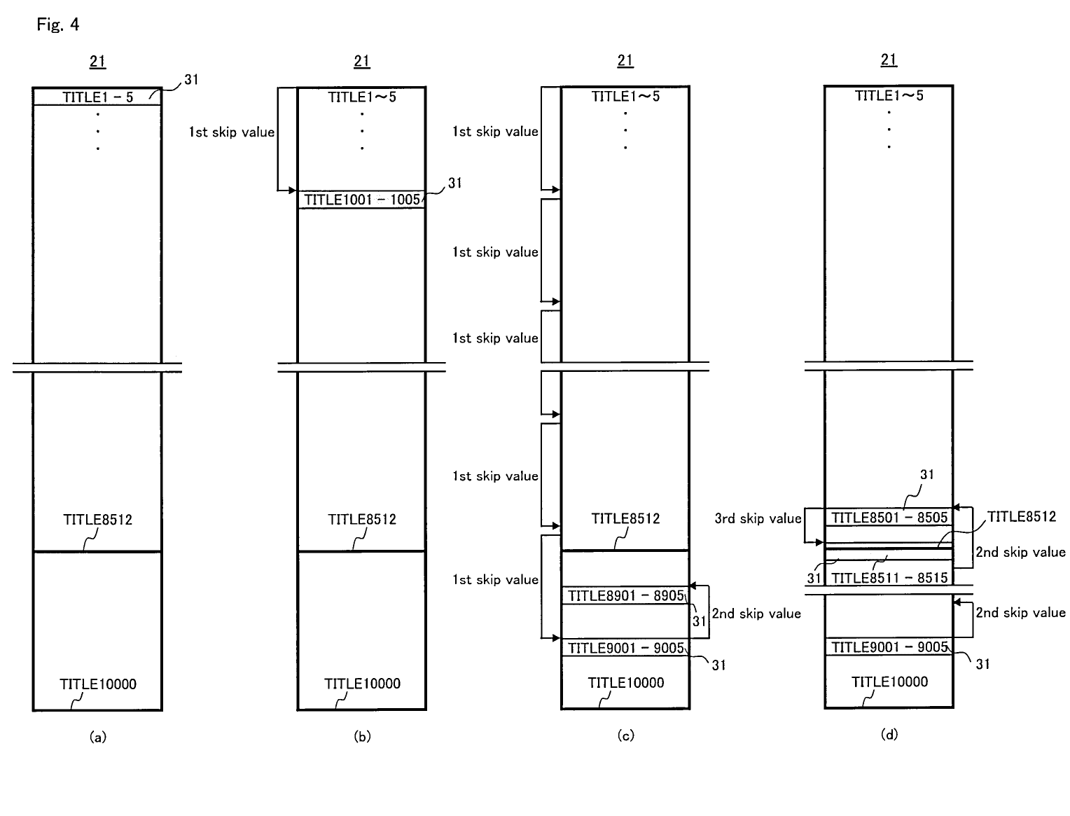

Referring to FIG. 3, the content selection device 1 displays a portion of a content list 21 on the OSD screen 31 of the display device 3. The number of tunes that can be displayed on the OSD screen 31 is limited (hereinafter referred to as the “maximum display number”). Where the maximum display number is five, the content selection device 1 first displays titles of the first five tunes (“TITLE1” to “TITLE5”) on the OSD screen 31.

Assume that the user wishes to listen to the 8512^{th} tune (title: “TITLE8512”) in the content list 21. A method for selecting the intended tune title “TITLE8512” will now be described.

For example, with a conventional method in which the user selects an intended tune title by pressing a push button on the remote controller, a single activation of which moves a cursor 32 on the OSD screen 31 down by one line, the user needs to press the push button 8511 times before selecting the intended tune title “TITLE8512”. Another conventional method is where a “page scroll” function is used, i.e., each time the user presses a push button, the next page of the screen to the currently-displayed page is displayed. If the push button is pressed when “TITLE1” to “TITLE5” are being displayed on the OSD screen 31, the next page (i.e., “TITLE6” to “TITLE10”) will be displayed on the OSD screen 31. Thus, by pressing the push button, the user can jump down the list by five tunes. With this method, however, the user still needs to press the push button 1700 times or more before reaching the intended tune title “TITLE8512”.

In view of this, the present embodiment employs skip values, each being a predetermined fraction of the total number of tune titles listed in the content list 21, in order to reduce the number of commands required to reach the intended tune title. Specifically, the content selection device 1 first obtains the total number TN of tunes listed in the content list 21, and determines a plurality of skip values (the first to n^{th} skip values) (n is a natural number) based on Expression A below.

n^{th} skip value=TN×(P/100)n Exp. A

Herein, P denotes the reference skip rate being the skip rate for the first skip value (i.e., n=1). The skip rate for the n^{th} skip value is (P/100)n×100(%).

The n^{th} skip value obtained by Expression A above is supposed to be a natural number. Fractions may be rounded up, down or off.

For example, the first to third skip values for the content list 21 can be calculated as follows, with the reference skip rate P being 10%.

First skip value=10000×(10/100)1=1000

Second skip value=10000×(10/100)2=100

Third skip value=10000×(10/100)3=10

Referring to FIG. 4, the OSD screen 31 including the tune titles “TITLE1” to “TITLE5” of the content list 21 is displayed on the display device 3 (see (a) in FIG. 4). In FIG. 4, a hatched region of the content list 21 represents the set of tune titles displayed on the OSD screen 31. When the user wishes to move the OSD screen 31 down the content list 21 (in the forward direction, i.e., the direction in which the tune titles are sorted in ascending order) (this operation will hereinafter be referred to as “jumping down”), the user presses a push button (jump down button) on the remote controller 5. Then, the user jumps forward from the tune title “TITLE1” over a number of tune titles equal to the first skip value (=1000), whereby “TITLE1001” to “TITLE1005” are displayed on the OSD screen 31 (see (b) in FIG. 4). The items in the content list 21 are sorted in alphabetical order. Therefore, seeing the tune titles “TITLE1001” to “TITLE1005” on the OSD screen 31, the user determines that the intended tune title “TITLE8512” is further below the currently-displayed tune titles “TITLE1001” to “TITLE1005”. Then, the user presses a push button (jump down button) to further jump down the list by a number of tune titles equal to the first skip value (=1000).

After the user jumps down the list by the first skip value nine times, the tune titles “TITLE9001” to “TITLE9005” are displayed on the OSD screen 31 (see (c) in FIG. 4). Seeing the OSD screen 31, the user determines that the user has gone down past the intended tune title “TITLE8512”. Accordingly, the user moves the OSD screen 31 up the content list 21 (in the backward direction) by the second skip value (=100) (this operation will hereinafter be referred to as “jumping up”). When the user presses a push button (jump up button) on the remote controller 5, the user jumps up the list (in the backward direction) from the tune title “TITLE9001” by the second skip value (=100), whereby the tune titles “TITLE8901” to “TITLE8905” are displayed (see (c) in FIG. 4).

After the user jumps up the list by the second skip value five times, the tune titles “TITLE8501” to “TITLE8505” are displayed on the OSD screen 31 (see (d) in FIG. 4). Then, the user determines that the user has gone up past the intended tune title “TITLE8512”. Accordingly, the user jumps down the list by the third skip value (=10). After the user jumps down the list once, tune titles “TITLE8511” to “TITLE8515”, which include “TITLE8512”, are displayed on the OSD screen 31 (see (d) in FIG. 4). After finding the intended tune title “TITLE8512” on the OSD screen 31, the user moves the cursor onto, and selects, the tune title “TITLE8512”.

Since the skip value is varied depending on the total number of tunes, the user can jump down or up the list with an appropriate skip value depending on the total number of tunes. Moreover, more than one skip values are used, whereby it is possible to further reduce the total number of times the user needs to press push buttons, i.e., the total number of commands to be issued.

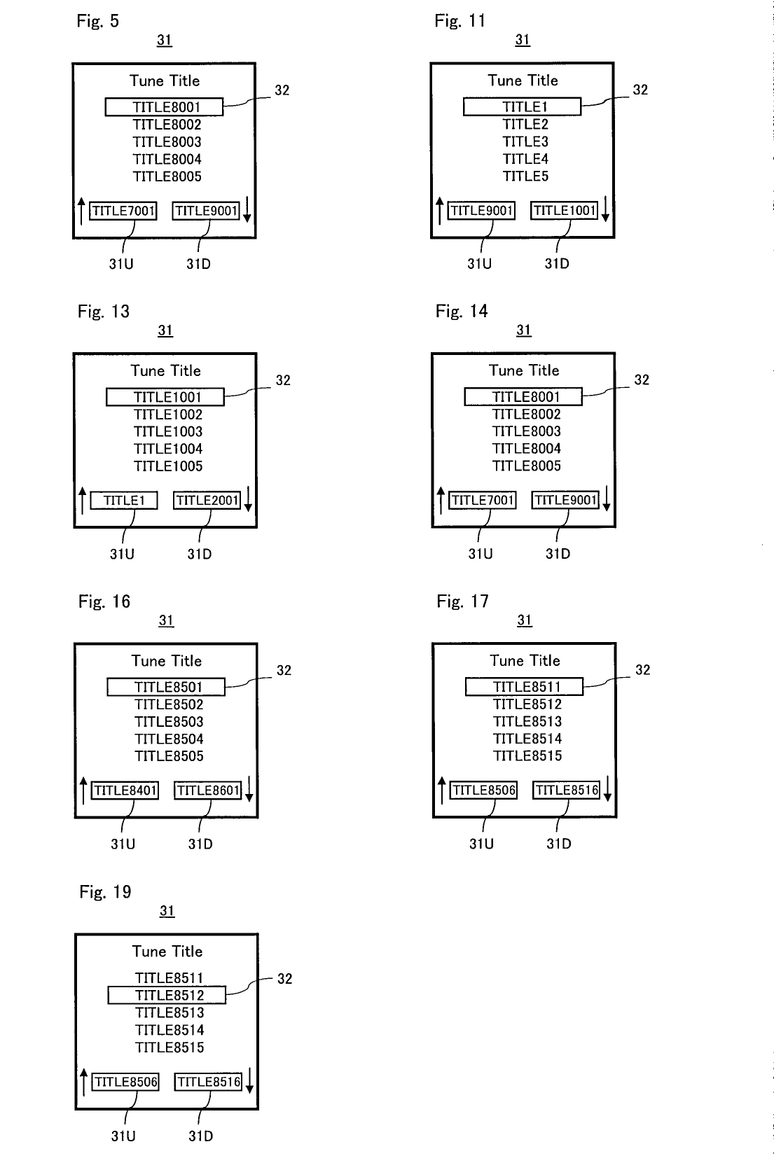

With the above content selection process, it is difficult for the user to estimate the position of the intended tune title in the content list 21 before moving past the intended tune title as a result of the downward or upward jump operation. In order to prevent the user from moving past the intended tune title, a method as shown in FIG. 5 may be employed, in which the OSD screen 31 shows a downward jump destination display area 31D (indicating the title of the tune to be shown at the top of the OSD screen after the next downward jump operation) and an upward jump destination display area 31U (indicating the title of the tune to be shown at the top of the OSD screen after the next upward jump operation). Then, the user can see the tune title shown in the downward jump destination display area 31D (hereinafter referred to as the “downward jump destination tune title”) and the tune title shown in the upward jump destination display area 31U (hereinafter referred to as the “upward jump destination tune title”), whereby it is possible to prevent the user from moving past the intended tune title. By seeing the downward jump destination tune title and the upward jump destination tune title, the user can continue to jump up or down the list while selecting a smaller skip value before moving past the intended tune title.

A configuration of the content selection device 1 for realizing such a content selection process will now be described.

### Content Selection Device

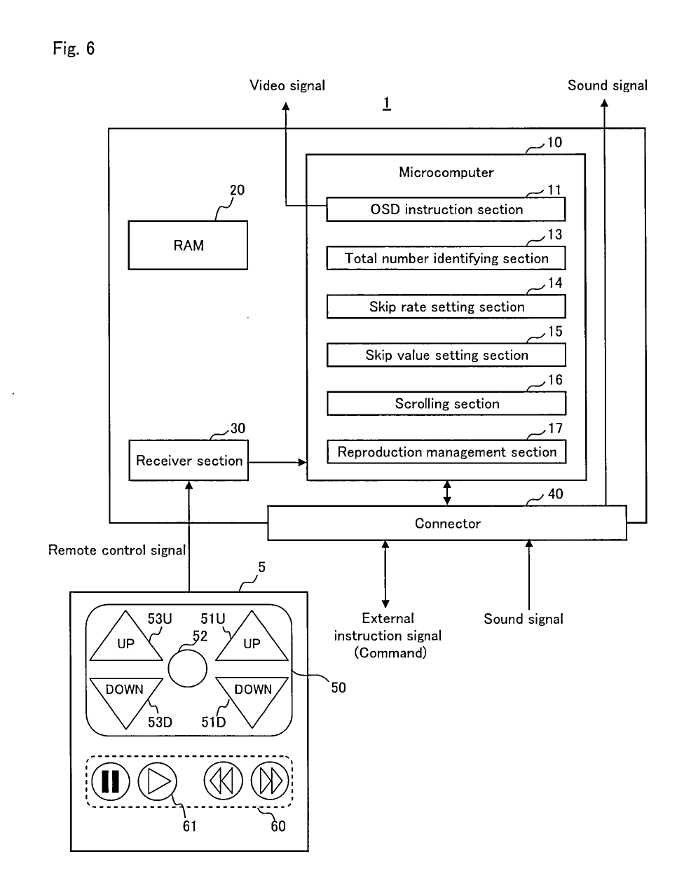

Referring to FIG. 6, the content selection device 1 performs the content selection process as described above in response to the operation of push buttons on the remote controller 5.

The push buttons provided on the remote controller 5 include scroll buttons 50 used for finding an intended tune title, and media control buttons 60 used for reproducing and stopping the intended tune title and for reproducing the intended tune title in a special manner. The scroll buttons 50 include a jump down button 51D, a jump up button 51U, a skip value changing button 52, a cursor down button 53D, and a cursor up button 53U.

The jump down button 51D is a button for a downward jump operation and, when activated, outputs a list scroll command in which the scrolling direction is the downward (forward) direction. The jump up button 51U is a button for an upward jump operation and, when activated, outputs a list scroll command in which the scrolling direction is the upward (backward) direction.

The skip value changing button 52 is a button for changing the skip value and, when activated, outputs a skip value changing command. The cursor down button 53D is a button used for moving the cursor down the list (in the forward direction) by one line and, when activated, outputs a cursor moving command in which the cursor moving direction is the downward direction. The cursor up button 53U is a button used for moving the cursor up the list (in the backward) and, when activated, outputs a cursor moving command in which the cursor moving direction is the upward direction.

The media control buttons 60 include a play button 61 for issuing an instruction to reproduce the tune whose title is being selected by the cursor on the OSD screen 31. When the play button 61 is pressed, the tune title over which the cursor is being displayed at that point is selected as the title of the tune to be reproduced. The play button 61 outputs a select command.

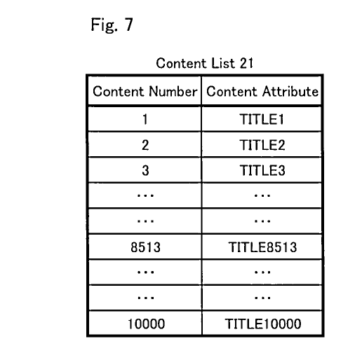

The content selection device 1 includes a microcomputer 10, a RAM (Random Access Memory) 20, a receiver section 30, and a connector 40. The RAM 20 temporarily stores content attributes needed to display the OSD screen 31, among others in the content list 21 stored in the audio player 2. The content list 21 stored in the audio player 2 has a content number field for storing content numbers and a content attribute field for storing content attributes, e.g., the tune titles “TITLE1” to “TITLE10000”, as shown in FIG. 7. The content numbers are given in the order the tune titles are sorted.

The receiver section 30 receives a command sent from the remote controller 5 when a push button on the remote controller 5 is pressed. The receiver section 30 outputs the received command.

The microcomputer 10 includes an OSD instruction section 11, a total number identifying section 13, a skip rate setting section 14, a skip value setting section 15, a scrolling section 16, and a reproduction management section 17.

The total number identifying section 13 identifies the total number TN of tunes in the content list 21. Specifically, the total number identifying section 13 obtains the last (highest) content number in the content list 21 from the audio player 2. The total number identifying section 13 obtains the last content number and identifies it as being the total number TN of tunes. Alternatively, the total number identifying section 13 may request the audio player 2 to return the total number TN of tunes so that the total number TN of tunes is given from the audio player 2.

Based on the total number TN of tunes, the skip rate setting section 14 determines an optimal reference skip rate P for the content list 21. Specifically, the reference skip rate P is determined so as to minimize, for the given total number TN of tunes, the number of times push buttons are pressed, i.e., the number of commands to be sent from the remote controller 5. A specific method for determining such a reference skip rate P will be described later.

The skip value setting section 15 determines skip values based on the determined reference skip rate P. Another function of the skip value setting section 15 is to change a skip value to be used in a downward and upward jump operation in response to the activation of the skip value changing button 52.

In response to the activation of the jump down button 51D or the jump up button 51U, the scrolling section 16 moves the portion of the content list 21 displayed on the OSD screen 31 in the downward or upward direction by a predetermined skip value. Specifically, in response to a list scroll command, the scrolling section 16 identifies the title of the tune to be next displayed at the top of the OSD screen 31 (hereinafter referred to as the “top-of-screen tune title”). Then, the scrolling section 16 identifies all of a set of tune titles to be next displayed on the OSD screen 31 based on the identified top-of-screen tune title. Another function of the scrolling section 16 is to move the cursor on the OSD screen 31 down or up the list by one line in response to the activation of the cursor down button 53D or the cursor up button 53U.

If the command output from the receiver section 30 is a command that has been issued by pressing the media control buttons 60 (e.g., the select command), the reproduction management section 17 converts the command into a format for the audio player 2 and outputs the converted command to the audio player 2. Thus, the user can control the operation of the audio player 2 (e.g., to play a tune) by using the remote controller 5. When the reproduction management section 17 receives a sound signal of a tune file from the audio player 2, the reproduction management section 17 outputs the received sound signal to the amplifier 4.

The content selection device 1 implements functions as described above by having the microcomputer 10 execute a content selection program (not shown) stored in the RAM 20.

### Audio Player

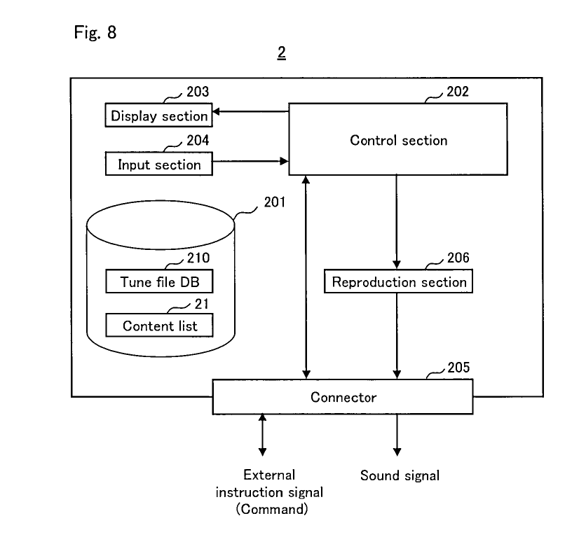

Referring to FIG. 8, the audio player 2 includes a storage section 201, a control section 202, a display section 203, an input section 204, a connector 205, and a reproduction section 206. The storage section 201 stores a tune file database 210 containing a plurality of tune files, and the content list 21 of the stored tune files.

The control section 202 has general control of the audio player 2. Specifically, in response to an instruction received from outside, the control section 202 can select the tune file of an intended tune title from among the tune files stored in the storage section 201 or instruct the reproduction section 206 to reproduce the intended tune file. The control section 202 can also sort items in the content list 21 in a predetermined order. For example, the control section 202 can sort the tune files in the content list 21 in alphabetical order or in aiueo order (in the order of the Japanese syllabary) of tune titles, or in the order of dates when they were stored in the storage section 201. In the present embodiment, the control section 202 sorts items in the content list 21 in alphabetical order. Moreover, the control section 202 transmits a tune title corresponding to a requested content number to the content selection device 1, in response to a request from the content selection device 1.

The reproduction section 206 reproduces a tune file to output a sound signal. The output sound signal is sent to the content selection device 1 via the connector 205.

The display section 203 can display a portion of the content list 21, as does the OSD screen 31, when the audio player 2 is used by itself. The input section 204 includes push buttons, similar to those on the remote controller 5, which are used to scroll the content list 21 displayed on the display section 203 and to reproduce a tune, when the audio player 2 is used by itself.

### Content Selection Process

The content selection process performed by the content selection device 1 having such a configuration will now be described.

First, the content selection device 1 determines skip values based on the total number TN of tunes in the content list 21 (skip value setting process S1100).

Then, the content selection device 1 moves the OSD screen 31 displayed on the display device 3 up or down the content list 21 by one of the determined skip values (skip process S200). When the skip value changing button 52 is pressed, the content selection device 1 changes the skip value (skip value changing process S300).

When the tune title displayed on the OSD screen 31 is close to the intended tune title, the user presses the cursor down button 53D or the cursor up button 53U. Each time the cursor down button 53D or the cursor up button 53U is pressed, the content selection device 1 moves the cursor 32 down or up the list by one line (cursor moving process S400).

With the intended tune title being selected by the cursor, the user presses the play button 61. At this point, the content selection device 1 selects the tune title over which the cursor 32 is being displayed on the OSD screen 31. Moreover, the content selection device 1 instructs the audio player 2 to reproduce the tune file corresponding to the selected tune title (reproduction instruction process S500). The processes (S100 to S500) to be performed until the user selects the intended tune title “TITLE8512” will be described.

### Skip Value Setting Process (S100)

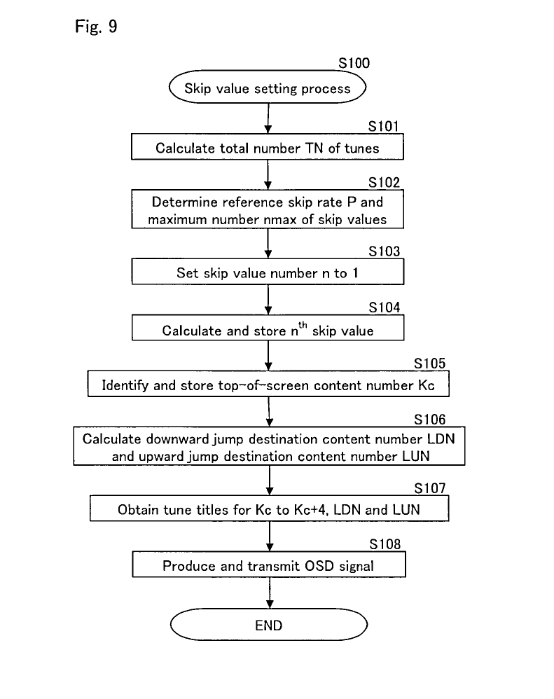

Referring to FIG. 9, the content selection device 1 first identifies the total number of tunes listed in the content list 21 of the audio player 2 (S101).

The total number identifying section 13 receives, from the audio player 2, the highest (last) content number in the content list 21, and identifies the obtained content number as being the total number TN of tunes. Alternatively, the total number identifying section 13 can obtain the total number TN of tunes by instructing the audio player 2 to count the tune titles listed in the content list 21.

After identifying the total number TN of tunes, the skip rate setting section 14 determines an optimal reference skip rate P(%) for the total number TN of tunes, and the number of skip values to be determined, i.e., the maximum number ‘nmax’ of skip values (S102). Specifically, the maximum number nmax of skip values is defined as shown in Expression 2 below, and the skip rate setting section 14 obtains nmax and P(%) such that the value of Expression 3 is minimum.

n max≦α Exp. 2

(100/P)×n max+n max+TN/(100/P)n max Exp. 3

Herein, α is a natural number.

Expression 3 above represents the maximum number of commands (i.e., the maximum number of times the user needs to press push buttons on the remote controller 5) for a particular value of P and a particular value of nmax being set for the total number TN of tunes in the content list 21.

The first term of Expression 3, (100(%)/P(%))×nmax, represents the sum of the maximum numbers of commands for the first to nmax^{th} skip values by which the content list 21 is scrolled. More specifically, (100(%)/P(%)) is the maximum number of commands to be issued before it is determined that the user has moved past the intended tune in a case where the content list 21 is scrolled in one direction by one of the skip values (the first to nmax^{th} skip values). For example, where TN=10000 and P=10%, the first skip value is 1000. When a list of 10000 tunes is scrolled in one direction (e.g., in the downward direction) by a number of tunes equal to the first skip value (1000 tunes), there will be issued 10000 tunes/1000 tunes=(100%/10%)=10 commands at maximum before it is determined that the user has moved past the intended tune. When P=10%, the second skip value is 100. At this point, as a result of roughly narrowing down the range of search with the first skip value, the total number of tunes to jump through is 1000. When a list of 1000 tunes is scrolled in one direction by a number of tunes equal to the second skip value (100 tunes), there will be issued 1000 tunes/100 tunes=(100%/10%)=10 commands at maximum. Thus, the maximum number of commands to be issued through the operation of scrolling the list by the first to nmax^{th} skip values can be obtained by multiplying (100(%)/P(%)) by nmax.

The second term, nmax, represents the maximum number of times the skip value is changed (i.e., the maximum number of times the skip value changing button 52 is pressed). The third term, TN/(100%/P %)nmax, is the maximum number of times the cursor moving command is issued before reaching the intended tune title by moving the cursor line by line after having scrolled the list by the nmax^{th} skip value. The value of this term is equivalent to the nmax^{th} skip value. Thus, the sum of the first to third terms of Expression 3 represents the expected maximum number of commands to be issued. Therefore, a combination of nmax and P that minimizes the value of Expression 3 is the combination that minimizes the total number of commands to be issued for the total number TN of tunes.

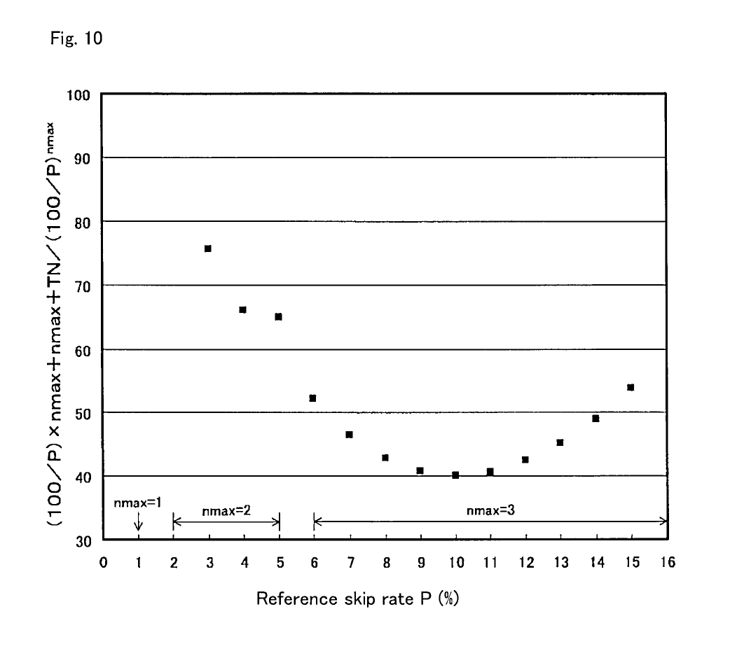

For example, where TN=10000 and a=3, the value of Expression 3 is minimized when nmax=3 and P=10(%) as shown in FIG. 10.

While the upper limit α is set for the maximum number nmax of skip values in the example discussed above, nmax and P that minimize Expression 3 can be obtained without such an upper limit.

After the skip rate setting section 14 determines the reference skip rate P and the maximum number nmax of skip values, the skip value setting section 15 sets the skip value number to 1 (S103). The skip value number n is stored in the RAM 20. Then, the skip value setting section 15 calculates the skip value for n=1 (i.e., the first skip value) (S104). Specifically, the skip value setting section 15 obtains the n^{th} skip value based on Expression A below.

n^{th} skip value=TN×(P/100)n Exp. A

Where TN=10000, the first skip value is 10000×(10/100)1=1000 based on Expression A. The skip value setting section 15 stores the obtained skip value (=1000) in the RAM 20.

Then, the scrolling section 16 identifies the content number of the tune whose title is displayed at the top of the OSD screen 31 (hereinafter referred to as the “top-of-screen content number”) Kc to be “1”. The identified top-of-screen content number Kc is stored in the RAM 20 (S105). Thus, the OSD instruction section 11 can display a number of tune titles equal to the maximum display number (five), starting from the first tune title in the content list 21 (hereinafter referred to as the “top-of-screen tune title”).

Then, the scrolling section 16 calculates, based on Expression 4, the content number of the downward jump destination tune title (hereinafter referred to as the “downward jump destination content number LDN”) to be displayed in the downward jump destination display area 31D on the OSD screen 31 (S106).

LDN=Kc+n^{th} skip value Exp. 4

Since Kc is “1” and the first skip value is 1000, the downward jump destination content number LDN is 1001. The calculated downward jump destination content number LDN is stored in the RAM 20. Thus, the downward jump destination tune title can be displayed in the downward jump destination display area 31D on the OSD screen 31.

The scrolling section 16 may calculate, based on Expression 10 below, the content number of the upward jump destination tune title to be displayed in the upward jump destination display area 31U on the OSD screen 31 (hereinafter referred to as the “upward jump destination content number LUN”).

LUN=Kc+TN−n^{th} skip value Exp. 10

Since the first skip value is 1000 and the total number TN of tunes is 10000, the upward jump destination content number LUN is 9001.

LUN may be calculated based on Expression 11 below.

LUN=Kc−n^{th} skip value Exp. 11

If LUN<1 based on Expression 11, LUN may be adjusted to 1 or 10000 (=TN).

Then, the scrolling section 16 obtains, from the audio player 2, the tune titles to be displayed on the OSD screen 31 (S107). The scrolling section 16 first reads out the top-of-screen content number Kc stored in the RAM 20. Then, based on the maximum display number of the OSD screen 31 (five in the illustrated example), the scrolling section 16 identifies the content numbers Kc to Kc+4, i.e., a number of content items equal to the maximum display number starting from the top-of-screen tune title. Herein, the scrolling section 16 identifies the content numbers of the tune titles to be displayed as being 1 to 5.

Then, the scrolling section 16 obtains, from the audio player 2, tune titles corresponding to the content numbers Kc to Kc+4. The scrolling section 16 also obtains, from the audio player 2, the tune title corresponding to the downward jump destination content number LDN and that corresponding to the upward jump destination content number LUN. Specifically, the scrolling section 16 issues a tune title request command to the audio player 2, wherein the tune title request command includes the content numbers Kc to Kc+4, LDN and LUN. In response to the tune title request command, the audio player 2 reads out, from the content list 21, the tune titles corresponding to Kc to Kc+4, LDN and LUN, i.e., “TITLE1” to “TITLE5”, “TITLE1001” and “TITLE9001”, and returns the tune titles to the content selection device 1.

After obtaining the tune titles “TITLE1” to “TITLE5”, “TITLE1001” and “TITLE9001” to be displayed on the OSD screen 31, the OSD instruction section 11 produces an OSD signal for the display device 3 to display the OSD screen 31 as shown in FIG. 11, and outputs the produced OSD signal to the display device 3 (S107).

The OSD instruction section 11 produces the OSD signal so that the OSD screen 31 displays the tune titles “TITLE1” to “TITLE5” in the order they are sorted in the content list 21, and displays the tune titles “TITLE1001” and “TITLE9001” in the downward jump destination display area 31D and the upward jump destination display area 31U, respectively. The produced OSD signal is sent to the display device 3. In response to the OSD signal, the display device 3 displays the OSD screen 31 as shown in FIG. 11. At this point, the cursor 32 is displayed over the tune title being displayed at the top of the OSD screen 31. The cursor position on the OSD screen 31 is stored in the RAM 20 while being associated with the content number of the tune title being selected by the cursor 32. In the example shown in FIG. 11, the OSD instruction section 11 stores the cursor position associated with “1” (i.e., the content number of the tune title being selected by the cursor) in the RAM 20.

### Skip Process (S200)

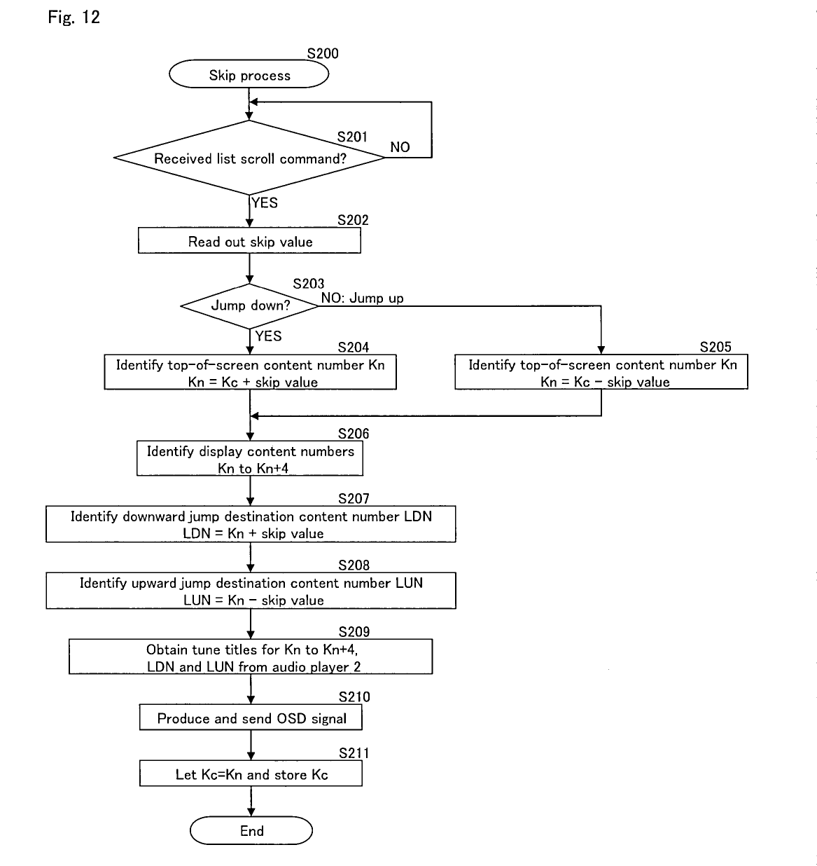

Referring to FIG. 12, the user searches for the intended tune title “TITLE8512”, looking at the OSD screen 31 on the display device 3.

The user presses the jump down button 51D on the remote controller 5 once in order to make a jump down the list. Then, the remote controller 5 issues a list scroll command in which the scrolling direction is the downward direction.

The scrolling section 16 monitors whether the receiver section 30 has received a list scroll command (S201). When it is determined that the receiver section 30 has received a list scroll command (YES in S201), the scrolling section 16 reads out the skip value stored in the RAM 20 (i.e., the first skip value=1000) (S202).

Then, the scrolling section 16 checks the scrolling direction of the received command (S203). The scrolling direction of the current received command is the downward direction (YES in S203), and therefore the scrolling section 16 identifies one of the set of tune titles to be displayed on the OSD screen 31 that is to be displayed at the top of the screen (the “top-of-screen tune title”) after the downward jump operation (S204). Specifically, the content number of the top-of-screen tune title (hereinafter referred to as the “top-of-screen content number”) Kn is calculated based on Expression 5 below.

Kn=Kc+skip value Exp. 5

If it is determined in step S203 that the scrolling direction is the upward direction (NO in S203), the scrolling section 16 calculates the top-of-screen content number Kn based on Expression 6 below (S205).

If Kn>9996 based on Expression 5, Kn may be adjusted to 9996 (TN−4).

Kn=Kc−skip value Exp. 6

In the illustrated example, the determination result in step S203 is YES, and therefore the top-of-screen content number Kn is calculated based on Expression 5 to be 1001.

If Kn<1 based on Expression 5, Kn may be adjusted to 1.

Then, the scrolling section 16 identifies all the tune titles to be displayed on the OSD screen 31 after the downward jump operation. The scrolling section 16 identifies a number of tune titles equal to the maximum display number of the OSD screen 31 (=5) starting from the identified top-of-screen tune title. Specifically, the scrolling section 16 identifies the content numbers of the tunes to be displayed as being Kn to Kn+4 (S206). Herein, the identified content numbers Kn to Kn+4 are 1001 to 1005.

Then, the scrolling section 16 identifies the downward jump destination tune title and the upward jump destination tune title. The scrolling section 16 determines the downward jump destination tune title to be a tune title located at a distance of the skip value in the forward direction from the identified top-of-screen tune title, and determines the upward jump destination tune title to be a tune title located at a distance of the skip value in the backward direction from the identified top-of-screen tune title. Specifically, the scrolling section 16 obtains the downward jump destination content number LDN based on Expression 7 below (S207). Moreover, the scrolling section 16 obtains the upward jump destination content number LUN based on Expression 8 below (S208).

LDN=Kn+skip value Exp. 7

LUN=Kn−skip value Exp. 8

In the illustrated example, LDN=2001 based on Expression 7 and LUN=1 based on Expression 8. The scrolling section 16 stores the obtained downward jump destination content number LDN and the obtained upward jump destination content number LUN in the RAM 20.

If LDN>TN based on Expression 7, then LDN may be adjusted to TN or 1, or calculated based on LDN=Kn+skip value-TN.

If LUN<1 based on Expression 8, then LUN may be adjusted to 1 or TN, or calculated based on LUN=Kn−skip value+TN.

After obtaining Kn to Kn+4, LDN and LUN, the scrolling section 16 obtains, from the audio player 2, tune titles corresponding to Kn to Kn+4, LDN and LUN (“TITLE1001” to “TITLE1004”, “TITLE2001” and “TITLE1”) (S209).

After obtaining the tune titles, the OSD instruction section 11 produces the OSD signal based on the obtained tune titles (S210). The produced OSD signal is sent to the display device 3. The display device 3 receives the OSD signal to display the OSD screen 31 as shown in FIG. 13.

After sending the OSD signal, the scrolling section 16 lets Kc=Kn and stores the top-of-screen content number Kc (=1001) in the RAM 20 (S208). Thus, the content selection device 1 can identify the tune title that is being currently displayed at the top of the OSD screen 31.

As described above, the content selection device 1 performs the skip process S200 each time it receives the list scroll command, which is issued in response to the activation of the jump down button 51D or the jump up button 51U.

### Skip Value Changing Process (S300)

After the user presses the jump down button 51D eight times, the OSD screen 31 as shown in FIG. 14 is displayed on the display device 3.

Looking at the OSD screen 31, the user determines that the intended tune title “TITLE8512” is above the downward jump destination tune title “TITLE9001” displayed in the downward jump destination display area 31D. Then, the user changes the skip value from the first skip value to the second skip value.

The user first presses the skip value changing button 52 on the remote controller 5. In response to the activation of the skip value changing button 52, the remote controller 5 sends a skip value changing command. When the content selection device 1 receives the skip value changing command, the skip value setting section 15 performs a skip value changing process S300.

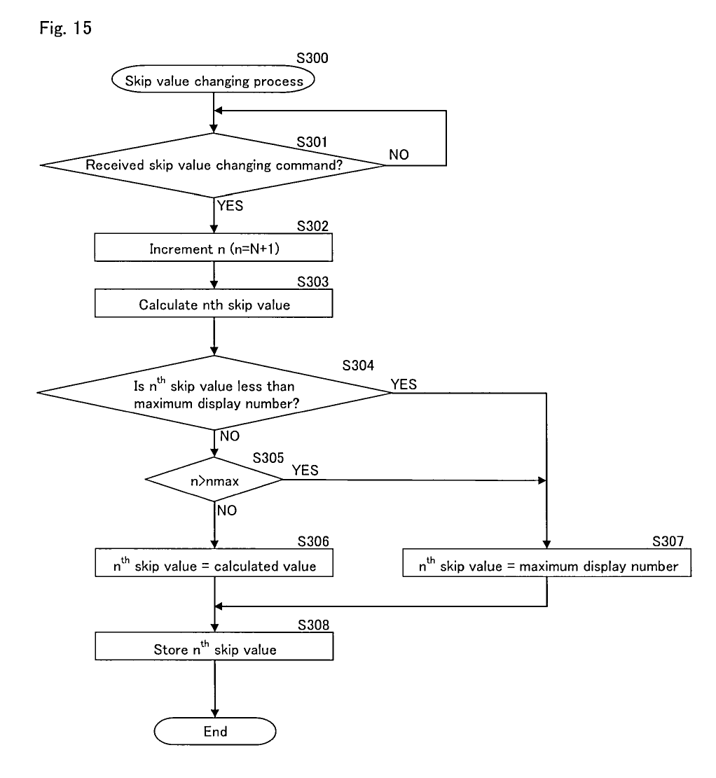

Referring to FIG. 15, when it is determined that the receiver section 30 has received a skip value changing command (YES in S301), the skip value setting section 15 increments the skip value number n (=1) stored in the RAM 20, whereby n=2 (S302). Where N denotes the accumulative number of times the skip value changing command has been received, the skip value number n calculated in step S302 can be obtained based on Expression 9 below. The accumulative number N of times the skip value changing command has been received may be stored in the RAM 20.

n=N+1 Exp. 9

Then, the skip value setting section 15 calculates the second skip value for the skip value number n (=2) based on Expression A (S303). Based on Expression 9, Expression A can be transformed to Expression 1 below.

n^{th} skip value=TN×(P/100)N+1 Exp. 1

In the illustrated example, the second skip value is 100. When the skip value changing command has been received once (i.e., N=1), the second skip value is obtained. In Expression 1, (P/100)1+1 represents the skip rate for the second skip value.

Then, the skip value setting section 15 determines whether the calculated skip value (the second skip value) is less than the maximum display number of the OSD screen 31 (S304). The second skip value is calculated to be “100”, which is larger than the maximum display number “5” (NO in S304), whereby the process proceeds to step S305.

In step S305, the skip value setting section 15 determines whether the skip value number n is larger than the maximum number nmax of skip values (S305). Since nmax is “3” (NO in S305), the skip value setting section 15 takes the value “100” calculated in step S303 as the second skip value (S306), and stores the skip value (the second skip value) (=100) in the RAM 20 (S308). Through an operation described above, the content selection device 1 can change the skip value to a smaller value based on Expression 1 each time a skip value changing command is received.

If the receiver section 30 receives a list scroll command after the skip value is changed to the second skip value, the content selection device 1 performs the skip process (S200), wherein the content list 21 on the OSD screen 31 is scrolled up or down by the second skip value.

After pressing the jump down button 51D five times with the second skip value, the OSD screen 31 as shown in FIG. 16 is displayed on the display device 3. Then, the user determines that the intended tune title “TITLE8512” is above the downward jump destination tune title “TITLE8601”. Therefore, the user presses the skip value changing button 52 to change the skip value. Then, the skip value setting section 15 performs the skip value changing process (S300) to change the skip value number n to 3 (S302) and obtain the third skip value “10” (S303).

The skip value calculated in the skip value changing process in step S303 may be less than the maximum display number “5” (YES in S304). Then, the skip value setting section 15 sets the skip value to “5”, equal to the maximum display number, instead of the value calculated in step S303 (S307). If the skip value is less than the maximum display number, the number of times the downward or upward jump operations are performed increases, and the number of commands also increases accordingly. In view of this, in the present embodiment, the increase in the number of commands is suppressed by setting the minimum skip value to be the maximum display number.

Also when the skip value number n is greater than the maximum number nmax of skip values (YES in S305), the skip value is set to the maximum display number (S307).

### Cursor Moving Process (S400) and Reproduction Instruction Process (S500)

After pressing the jump down button 51D once with the third skip value (=10), the display device 3 displays the OSD screen 31 including the intended tune title “TITLE8512” therein as shown in FIG. 17. Then, the user presses the cursor down button 53D to move the cursor 32 onto the tune title “TITLE8512”. In response to the activation of the cursor down button 53D, the remote controller 5 sends a cursor moving command in which the cursor moving direction is the downward direction to the content selection device 1.

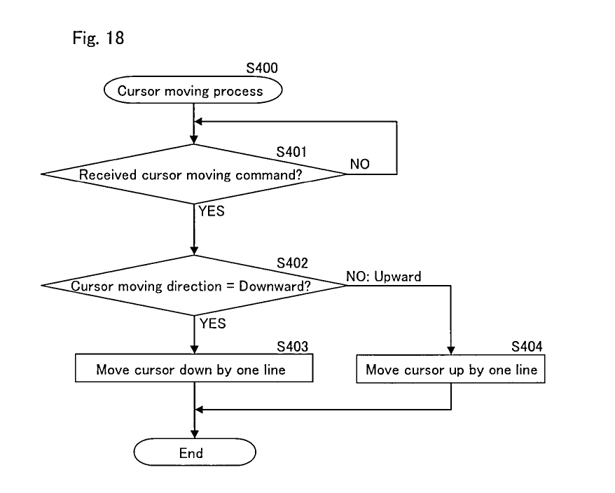

When the cursor moving command is received, the content selection device 1 performs the cursor moving process S400 shown in FIG. 18.

The scrolling section 16 monitors whether the receiver section 30 has received a cursor moving command (S401). When it is determined that the receiver section 30 has received a cursor moving command (YES in S401), the scrolling section 16 checks the cursor moving direction included in the received cursor moving command (S402).

Since the cursor moving direction of the received command is the downward direction (YES in S402), the scrolling section 16 moves the cursor 32 down the list by one line (S403). Specifically, the scrolling section 16 refers to the RAM 20 and reads out the content number (=8511) associated with the cursor position. Then, since the cursor moving direction is the downward direction, the content number associated with the cursor position is incremented to “8512”. Then, an OSD signal representing the OSD screen 31 where the cursor 32 is placed over the tune title “TITLE8512” (the content number=8512) is output to the display device 3. The display device 3 receives the OSD signal, and displays the OSD screen 31 as shown in FIG. 19. The incremented content number “8512” is stored in the RAM 20.

By a method described above, the user can move the cursor 32 onto the intended tune title “TITLE8512”. When the user presses the cursor up button 53U, the scrolling section 16 determines in step S402 that the cursor moving direction is the upward direction (NO in S402), and therefore moves the cursor 32 on the OSD screen 31 up the list by one line (S404). Specifically, the scrolling section 16 refers to the RAM 20 to read out the content number associated with the cursor position and decrement the content number by one.

After moving the cursor 32 onto the intended tune title “TITLE8512”, the user presses the play button 61. In response to the activation of the play button 61, the remote controller 5 sends a select command.

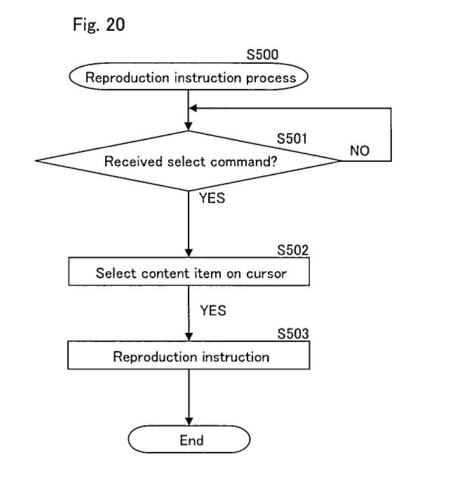

When the select command is received, the content selection device 1 performs the reproduction instruction process S500 shown in FIG. 20. When it is determined that the receiver section 30 has received a select command (YES in S501), the reproduction management section 17 determines that the content number associated with the cursor position in the RAM 20 is 8512 and therefore selects the content number 8512 of the intended tune title “TITLE8512” (S502).

After selecting the content number 8512, the reproduction management section 17 sends a reproduction instruction to the audio player 2 to reproduce the tune file of the content number 8512 (S503). Receiving the reproduction instruction, the audio player 2 reproduces the tune file of the tune title “TITLE8512” to send the sound signal to the content selection device 1.

As described above, the content selection device 1 of the present embodiment determines a skip value proportional to the total number of tunes is determined. Then, each time the jump down button 51D or the jump up button 51U is pressed, the content selection device 1 displays the OSD screen 31 showing a new set of tune titles that are located at positions down or up the list by the skip value from the previously displayed set of tune titles. Therefore, the total number of commands to be sent from the remote controller 5 before the intended tune title is found can be suppressed, and it is possible to reduce the total number of times the user needs to press push buttons.

Since the skip value is varied according to the total number of tunes, downward and upward jump operations can be performed with an appropriate skip value for the total number of tunes. By setting the first to n^{th} skip values, it is possible to further reduce the total number of times the user needs to press push buttons.

Moreover, the OSD screen 31 includes the downward jump destination display area 31D and the upward jump destination display area 31U for showing the downward jump destination tune title and the upward jump destination tune title, respectively, whereby it is possible to prevent the user from moving past the intended tune title by a downward or upward jump operation.

Note however that the content selection device 1 of the present embodiment does not have to show the downward jump destination tune title and the upward jump destination tune title. Even without these indications, the user can reach the intended tune title with a few button pressing operations by the method shown in FIG. 4.

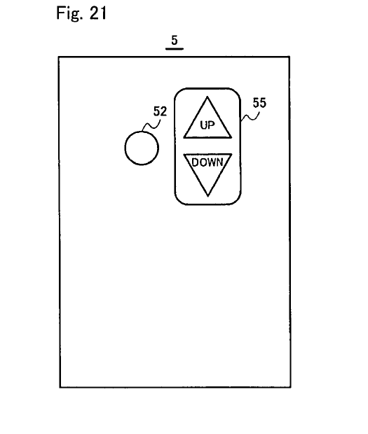

In the present embodiment, the cursor down button 53D and the cursor up button 53U are provided separately from the jump down button 51D and the jump up button 51U. Alternatively, as shown in FIG. 21, scroll buttons 55 may be used for both jump operations and cursor up/down operations. In such a case, the scroll buttons 55 may be controlled to function as jump up/down buttons or as cursor up/down buttons according to the number of times the skip value changing button 52 is pressed.

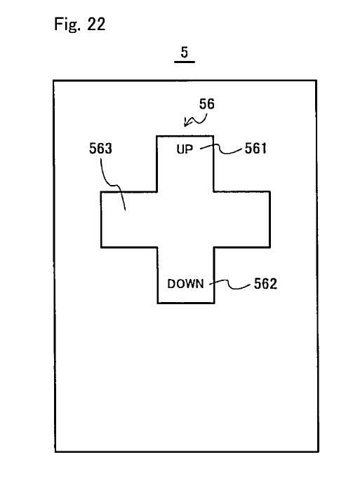

Alternatively, a cross-shaped button 56 as shown in FIG. 22 may be provided on the remote controller 5, wherein an upper portion 561 of the cross-shaped button 56 is assigned an upward jump function and a cursor up function, a lower portion 562 is assigned a downward jump function and a cursor down function, and a left or right portion (e.g., a left portion 563) is assigned a skip value changing function.

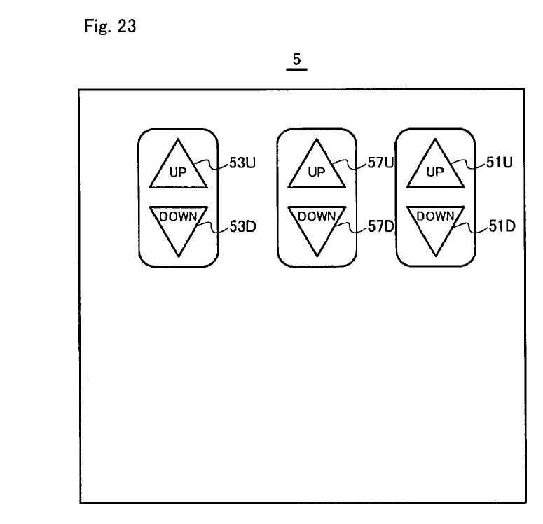

In the present embodiment, the skip value changing button 52 is provided. Alternatively, as shown in FIG. 23, the skip value changing button may be omitted, and a jump up button 57U and a jump down button 57D for the second skip value may be provided separately from the jump up button 51U and the jump down button 51D for the first skip value. In this case, a list scroll command includes skip rate identifying information for identifying the skip rate, as a piece of information for identifying the requested skip value (the first or second skip value).

In such a case, the skip value setting section 15 does not perform the skip value changing process S300 shown in FIG. 15, but changes the skip value according to the received list scroll command. When a list scroll command is received, the skip value setting section 15 refers to the skip rate identifying information to identify the skip rate. Then, the first skip value or the second skip value is set based on the identified skip rate.

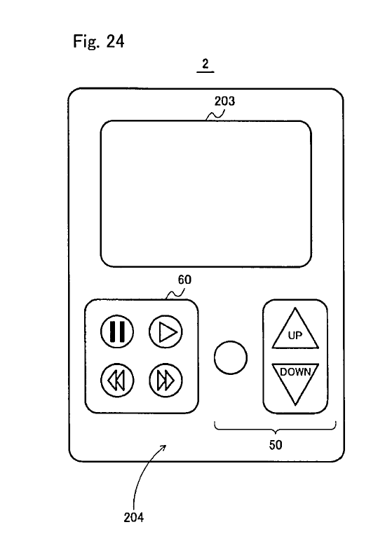

In the present embodiment, the content selection device 1 and the audio player 2 are separate from each other. Alternatively, as shown in FIG. 24, the content selection device 1 may be included in the audio player 2. In such a case, the input section 204 includes the scroll buttons 50 and the media control buttons 60 similar to those of the remote controller 5, and the same screen as the OSD screen 31 is displayed on the display section 203.

In the content selection process of the present embodiment, tunes are sorted in alphabetical order of the content attribute (tune title). Alternatively, the sorting may be in aiueo order (in the order of the Japanese syllabary) or in the order of the “last updated” value. The sorting criterion is not limited to any particular criterion as long as the user can look at the OSD screen 31 and determine whether the intended content item is above or below the set of content items being displayed on the OSD screen 31.

In the content selection process of the present embodiment, the content number of a tune title to be displayed on the OSD screen 31 is first identified, and the tune title of the identified content number is obtained from the audio player 2. Alternatively, the content list 21 may be obtained from the audio player 2 and stored in the RAM 20. In such a case, the content selection device 1 does not have to request the audio player 2 for tune titles. However, in order to store the content list 21 in the RAM 20, the memory (RAM) provided in the content selection device 1 needs to have a large size. In a case where the content selection device 1 obtains the content list 21, items of the content list 21 may be sorted by the content selection device 1.

In the present embodiment, the top-of-screen content number Kc is identified to be “1” in step S1105 in the skip value setting process (S100). Alternatively, the top-of-screen content number Kc may be a content number different from “1”. For example, the content number of the top-of-screen tune title, which was previously displayed on the OSD screen 31, may be stored in the content selection device 1, and the stored content number may be later used as the top-of-screen content number Kc in the skip value setting process (S100).

The content list 21 stored in the audio player 2 may be sorted only after receiving a sort instruction from the content selection device 1. In other words, the content list 21 does not need to be sorted in advance. The content list 21 needs to be sorted only when the content selection device 1 performs the content selection process.

Moreover, the sorting criterion of the content list 21 may be changed before performing the content selection process. For example, the content list 21 may be stored in the audio player 2 sorted in aiueo order, and then resorted in alphabetical order in response to an instruction from the content selection device 1 before the content selection process is performed.

In the present embodiment, commands from the remote controller 5 are received by the content selection device 1 to perform the content selection process. Alternatively, commands from the remote controller 5 may be received by the amplifier 4, and the amplifier 4 may relay the commands to the content selection device 1.

In the present embodiment, the skip rate for the first to n^{th} skip values is (P/100)n. Alternatively, a predetermined skip rate may be set for each of the first to n skip values. In such a case, the skip rates for different skip values need to be stored in the RAM 20 in advance, which requires a larger memory size than the present embodiment.

The types of content that can be used in the present invention are not limited to those mentioned above: music (sound) files, video files and still images. Other types of content items may include various types of files stored in a personal computer, digital camera picture data, email messages received on a mobile telephone, TV program files recorded on an HDD or DVD recorder, video or music data stored on the server of a server-client system (e.g., a network AV system), a list of destinations stored in a car navigation system, dictionary data (a list of words) of an electronic dictionary, a list of goods (inventory) of POS (point-of-sales system), etc.

While the present invention has been described above in a preferred embodiment, it is understood that the embodiment is merely illustrative of how the invention may be carried out, and it is apparent to those skilled in the art that variations and modifications thereof can be made without departing from the spirit and scope of the invention.

What is claimed is:

1. A content selection device, which can be connected to a content storage device, a display device and an input device, wherein the content storage device stores a plurality of content items and a content list being a list of content attributes for identifying the content items, the display device has a display screen for displaying a subset of the content attributes listed in the content list, and the input device outputs a plurality of commands according to user operations, the content selection device comprising:
a total number identifying section, which identifies a total number of content attributes in the content list;
a skip value setting section, which determines a skip value being a predetermined percentage of the identified total number of content attributes;
a top-of-screen content attribute identifying section, which identifies a top-of-screen content attribute being one of the content attributes listed in the content list that is offset from a content attribute being displayed at a top of the display screen by a distance corresponding to the skip value in the scrolling direction, when a list scroll command including a scrolling direction is received from the input device;
a display attribute specifying section, which specifies a set of content attributes from among the content attributes listed in the content list, the set including a number of content attributes listed in a forward direction in the content list starting from the top-of-screen content attribute, the number of content attributes in the set corresponding to a maximum display number of the display screen;
a display instruction section, which instructs the display device to sequentially display, on the display screen, the set of content attributes identified by the display attribute specifying section, starting from the top-of-screen content attribute;
a cursor moving section, which moves a cursor on the display screen by one content attribute in the cursor moving direction, when a cursor moving command including a cursor moving direction is received from the input device; and
a content attribute selecting section, which selects one of the set of content attributes displayed on the display screen that is being specified by the cursor, when a select command is received from the input device.

2. The content selection device according to claim 1, wherein:
the content list includes a plurality of content numbers, which indicate an order in which the content attributes are sorted; and
the top-of-screen content attribute identifying section, which identifies a content number associated with a content attribute being displayed at a top of the display screen, calculates a content number obtained by adding the skip value to the identified content number, and identifies a content attribute associated with the calculated content number as being the top-of-screen content attribute.

3. The content selection device according to claim 1, wherein the skip value setting section determines the skip value by multiplying the total number of content attributes by a predetermined skip rate.

4. The content selection device according to claim 3, wherein each time a skip value changing command is received from the input device, the skip rate is decreased, and the skip value setting section determines the skip value by multiplying the total number of content attributes by the decreased skip rate.

5. The content selection device according to claim 4, wherein if the skip value obtained by multiplication by the skip rate is smaller than the maximum display number of the display screen, the skip value setting section determines the skip value to be equal to the maximum display number.

6. The content selection device according to claim 4, wherein:
when the skip value changing command is received, the skip value setting section determines a skip value based on Expression 1 below:
skip value=TN×(P/100)N+1 Exp. 1
where TN is the total number of content attributes, P is a reference skip rate (%), and N is an accumulative number of times the content selection device has received the skip value changing command.

7. The content selection device according to claim 6, further comprising a skip rate setting section, which determines nmax and the reference skip rate P(%) that minimize a value of Expression 3 below, where nmax denotes a maximum number of skip values as defined in Expression 2 below:
n max≦α Exp. 2
(100/P)×n max+n max+TN/(100/P)n max Exp. 3
where α is a predetermined natural number,
wherein the skip value setting section determines the skip value based on the determined reference skip rate P.

8. The content selection device according to claim 1, further comprising a section, which identifies a downward jump destination content attribute being one of the content attributes listed in the content list that is offset from the identified top-of-screen content attribute by a distance corresponding to the skip value in a forward direction of the content list, and identifies an upward jump destination content attribute being one of the content attributes listed in the content list that is offset from the identified top-of-screen content attribute by a distance corresponding to the skip value in a backward direction of the content list,
wherein the display instruction section instructs the display screen to display information regarding the identified downward jump destination content attribute and information regarding the identified upward jump destination content attribute.

9. A content selection device, comprising:
a content storage device, which stores a plurality of content items and a content list being a list of content attributes for identifying the content items;
a display device, which has a display screen for displaying a subset of the content attributes listed in the content list;
a input device, which includes a plurality of push buttons for outputting a plurality of commands according to user operations;
a total number identifying section, which identifies a total number of content attributes in the content list;
a skip value setting section, which determines a skip value being a predetermined percentage of the identified total number of content attributes;
a top-of-screen content attribute identifying section, which identifies a top-of-screen content attribute being one of the content attributes listed in the content list that is offset from a content attribute being displayed at a top of the display screen by a distance corresponding to the skip value in scrolling direction of the content list, when a list scroll command including a scrolling direction sent from the input device in response to an activation of one of the push buttons is received;
a display attribute specifying section, which specifies a set of content attributes from among the content attributes listed in the content list, the set including a number of content attributes listed in a forward direction in the content list starting from the top-of-screen content attribute, the number of content attributes in the set corresponding to a maximum display number of the display screen;
a display instruction section, which instructs the display device to sequentially display, on the display screen, the set of content attributes identified by the display attribute specifying section, starting from the top-of-screen content attribute;
a cursor moving section, which moves a cursor on the display screen by one content attribute in the cursor moving direction, when a cursor moving command including a cursor moving direction sent from the input device in response to an activation of one of the push buttons is received; and
a content attribute selecting section, when a select command sent from the input device in response to an activation of one of the push buttons is received, selects one of the content attributes displayed on the display screen that is being specified by the cursor.

10. A computer program instructing a computer to perform an operation of a content selection device, which can be connected to a content storage device, a display device and an input device, wherein the content storage device stores a plurality of content items and a content list being a list of content attributes for identifying the content items, the display device has a display screen for displaying a subset of the content attributes listed in the content list, and the input device outputs a plurality of commands according to user operations, the content selection device comprising:
a total number identifying step of identifying a total number of content attributes in the content list;
a skip value setting step of determining a skip value being a predetermined percentage of the identified total number of content attributes;
a top-of-screen content attribute identifying step of identifying a top-of-screen content attribute being one of the content attributes listed in the content list that is offset from a content attribute being displayed at a top of the display screen by a distance corresponding to the skip value in the scrolling direction, when a list scroll command including a scrolling direction is received from the input device;
a display attribute specifying step of specifying a set of content attributes from among the content attributes listed in the content list, the set including a number of content attributes listed in a forward direction in the content list starting from the top-of-screen content attribute, the number of content attributes in the set corresponding to a maximum display number of the display screen;
a display instruction step of instructing the display device to sequentially display, on the display screen, the set of content attributes identified by the display attribute specifying section, starting from the top-of-screen content attribute;
a cursor moving step of moving a cursor on the display screen by one content attribute in the cursor moving direction, when a cursor moving command including a cursor moving direction is received from the input device; and
a content attribute selecting step of selecting one of the set of content attributes displayed on the display screen that is being specified by the cursor, when a select command is received from the input device.
